(19) United States
(12) Patent Application Publication
(10) Pub. No.: US 2007/0031643 A1
(43) Pub. Date: Feb. 8, 2007

(54) Panel structure for electronic apparatus and electronic apparatus

(76) Inventors: Koji Yakata, Kobe-shi (JP); Nobuyuki Ukai, Kobe-shi (JP); Shinsuke Yuri, Kobe-shi (JP); Shinji Hisatugu, Kobe-shi (JP); Yoshitugu Yamashita, Kobe-shi (JP); Hisao Takahashi, Toyota-shi (JP); Koichi Ando, Toyota-shi (JP)

Correspondence Address: HARNESS, DICKEY & PIERCE, P.L.C., P.O. BOX 8910, RESTON, VA, 20195, US

(21) Appl. No.: 11/498,851

(22) Filed: Aug. 4, 2006

(30) Foreign Application Priority Data
Aug. 5, 2005 (JP) 2005-228877

(51) Int. Cl. B32B 1/00

(52) U.S. Cl. 428/187

(57) ABSTRACT

There is provided a panel structure for an electronic apparatus that is capable of exhibiting two types of design images. During daytime hours for example, a design-applied portion of a panel main body can be visually recognized through a panel made of a light transmitting material. During nighttime hours for example, when light is conducted from one X direction-wise end to the other x direction-wise end in the panel, as well as from the other x direction-wise end to one X direction-wise end in the panel 1, the design-applied portion is shielded with the light illuminating the panel. In this way, by making a difference between the daytime visual impression and the nighttime visual impression of the panel, it is possible to impart two types of design images to the panel structure.

### BACKGROUND OF THE INVENTION

1. Field of the Invention

The present invention relates to a panel structure for an electronic apparatus, and an electronic apparatus having the same, and more particularly to a technology in panel structure applicable to a design panel section of an in-vehicle radio, for example.

In the specification and claims, the term “design-applied portion” refers to a portion which was subjected to a process of applying a design, and the term “printing-processed portion” refers to a portion which was subjected to a process of printing.

2. Description of the Related Art

There has been known to date a practicable technology in which characters are discernible by allowing light emitted from a light source to pass mainly through the character part of an operating button in the design panel section of an in-vehicle radio, for example (refer to Japanese Unexamined Patent Publication JP-A 2000-106049, for example).

In the conventional structure, however, the appearance of a design image remains substantially the same at any time of day or night, which leads to lack of interest. Even if the other region than the operating button is adjusted to be visually perceptible by utilizing illumination light in an attempt to make some change, the appearance of a design image per se still remains substantially the same at any time of day or night, as a matter of fact. Herein, the expression “substantially the same” signifies also “the same”.

### SUMMARY OF THE INVENTION

It is an object of the invention to provide a design panel structure for use in an electronic apparatus, having dual characters, which is more specifically a panel structure for the electronic apparatus that is capable of exhibiting two types of design images, and to provide the electronic apparatus.

The invention provides a panel structure for an electronic apparatus comprising:

a panel main body having an design-applied portion or a printing-processed portion; and

a panel made of a light transmitting material, for lowering viewability of the design-applied portion or printing-processed portion when light is conducted from a side part of the panel is lower than viewability of the design-applied portion or printing-processed portion when light is not conducted from the side part by shielding the design-applied portion or printing-processed portion with light.

According to the invention, during daytime hours for example, an applied design pattern or printed pattern formed in the panel main body can be visually recognized through the panel made of a light transmitting material. On the other hand, during nighttime hours for example, when light is conducted from the side parts of the panel, the applied design pattern or printed pattern is shielded with the light illuminating the panel. In this way, by making a difference between the daytime visual impression and the nighttime visual impression of the panel, it is possible to impart two types of design images to the panel structure.

In the invention, it is preferable that the printing-processed portion is composed of a print sheet body.

According to the invention, during daytime hours for example, the printing-processed portion of the print sheet body can be visually recognized through the panel made of a light transmitting material. By disposing the print sheet body in the existing panel structure, it is possible to impart two types of design images to the panel structure, and thereby enhance the general versatility of the panel structure.

In the invention, it is preferable that the printing-processed portion is fashioned by means of medium printing.

According to the invention, the printing-processed portion can be realized by performing medium printing on a back surface of the panel.

In the invention, it is preferable that the design-applied portion includes asperity.

According to the invention, the design-applied portion can be realized by forming asperity.

In the invention, it is preferable that the light transmitting material is selected from any one of acrylonitrile-butadiene-styrene copolymer, polycarbonate, acrylic substance, and glass.

According to the invention, the light transmitting material can be realized by selecting any one of acrylonitrile-butadiene-styrene copolymer, polycarbonate, acrylic substance, and glass.

The invention provides a panel structure for an electronic apparatus comprising:

a panel main body having a design-applied portion or printing-processed portion;

a light source provided on an end of the panel main body, for emitting light; and

a panel made of a light transmitting material, provided on an anterior surface of the panel main body, the panel being illuminated from a side part thereof with the light emitted from the light source which light shields the design-applied portion or printing-processed portion.

According to the invention, during nighttime hours for example, when light emitted from the light source is conducted, the design-applied portion or the printing-processed portion of the panel main body is shielded with the light illuminating the panel. On the other hand, during daytime hours for example, when no light is conducted from the light source, it is ensured that the design-applied portion or the printing-processed portion is recognized through the panel with high viewability. In this way, by making a difference between the daytime visual impression and the nighttime visual impression of the panel, it is possible to impart two types of design images to the panel structure.

The invention provides an electronic apparatus comprising:

a panel main body having a design-applied portion or printing-processed portion;

a light source provided on an end of the panel main body, for emitting light; and

a panel made of a light transmitting material, for lowering viewability of the design-applied portion or printing-processed portion when light is conducted from a side part of the panel is lower than viewability of the design-applied portion or printing-processed portion when light is not conducted from the side part by shielding the design-applied portion or printing-processed portion with light.

According to the invention, during daytime hours for example, an applied designed pattern or printed pattern formed in the panel main body can be visually recognized through the panel made of a light transmitting material. On the other hand, during nighttime hours for example, when light is conducted from the side parts of the panel, the applied design pattern or printed pattern is shielded with the light illuminating the panel. In this way, by making a difference between the daytime visual impression and the nighttime visual impression of the panel, it is possible to impart two types of design images to the electronic apparatus.

In the invention, it is preferable that the panel main body is applied to an in-vehicle apparatus.

According to the invention, the panel main body is applied onto an in-vehicle apparatus and it is thus possible to impart two types of design images to the in-vehicle electronic apparatus.

In the invention, it is preferable that the light source is composed of a plurality of light emitting diodes, and

the light emitting diodes are spaced out from one another at a constant distance.

According to the invention, the light source can be realized by a light emitting diode array composed of a plurality of light emitting diodes.

In the invention, it is preferable that the electronic apparatus further comprises a light-guiding plate disposed between the light source and the panel, for conducting the light to the side part of the panel.

According to the invention, the light emitted from the light source can be effectively conducted to the side part of the panel by the light-guiding plate.

### BRIEF DESCRIPTION OF THE DRAWINGS

Other and further objects, features, and advantages of the invention will be more explicit from the following detailed description taken with reference to the drawings wherein:

FIGS. 1A through 1C are views of a panel structure according to a first embodiment of the invention, with FIG. 1A showing a front view of the panel structure as seen during daytime hours, FIG. 1B showing a front view of the panel structure as seen during nighttime hours, and FIG. 1C showing a sectional view indicating the relationship between a panel and a panel main body;

FIG. 2 is a sectional view of the panel structure according to a second embodiment of the invention, wherein a design-applied portion is formed integrally with an inner panel section;

FIG. 3 is a sectional view of the panel structure according to a third embodiment of the invention, wherein the back surface of a panel is subjected to printing process;

FIG. 4 is a sectional view of the panel structure according to a fourth embodiment of the invention, wherein the back surface of a panel is subjected to UV-stripe printing process;

FIGS. 5A and 5B are views of the panel structure according to a fifth embodiment of the invention, with FIG. 5A showing a sectional view indicating the relationship between a panel and a panel main body including an outer panel and a stripe-patterned print sheet body, and FIG. 5B showing a sectional view schematically illustrating a polycarbonate-made print sheet body to which a stripe pattern is printed;

FIGS. 6A and 6B are views of the panel structure according to a sixth embodiment of the invention, with FIG. 6A showing a front view illustrating how light emitted from a light source is conducted to a panel embossed with a pattern, and FIG. 6B showing a sectional view of the state depicted in FIG. 6A;

FIGS. 7A and 7B are views of the panel structure according to a seventh embodiment of the invention, with FIG. 7A showing a front view schematically illustrating a light-shade distribution in a panel, and FIG. 7B showing a front view illustrating dot and pitch adjustment in the medium printing; and

FIGS. 8A through 8C are views of the panel structure according to an eighth embodiment of the invention, with FIG. 8A showing an exploded perspective view thereof, FIG. 8B showing a sectional view indicating the relationship among a light source, a light-guiding plate, a filter, and a panel, and FIG. 8C showing a sectional view of the principal portion of the panel structure.

### DETAILED DESCRIPTION

Now referring to the drawings, preferred embodiments of the invention are described below.

Hereinafter, the invention will be explained by way of a plurality of embodiments with reference to the accompanying drawings. Note that there may be case where the components of a given embodiment that play the same or corresponding roles as in the preceding embodiment will be identified with the same reference symbols, and overlapping descriptions will be omitted. That is, in the description as to a given embodiment, if only a part of the constitution thereof is explained, the rest of the constitution is regarded as being identical with that of the preceding embodiment. Note also that, not only it is possible to utilize the specifically described constituents of the different embodiments in combination, but it is also possible to combine the different embodiments partly with each other so long as the combined use poses no problem. Application of the panel structures of the embodiments, although they are designed originally for use in the design panel section of an in-vehicle radio, is not limited to such an electronic apparatus. For example, the invention is applicable to in-vehicle apparatuses of various type such as decks and navigation systems, as well as to other electronic apparatuses than in-vehicle apparatuses.

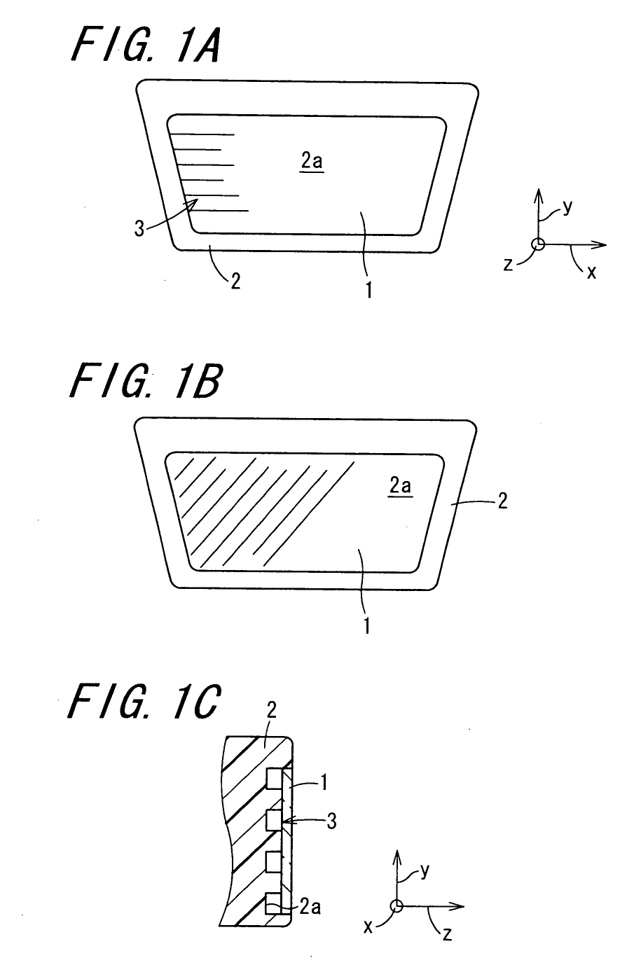

FIGS. 1A through 1C are views of a panel structure according to a first embodiment of the invention, with FIG. 1A showing a front view of the panel structure as seen during daytime hours, FIG. 1B showing a front view of the panel structure as seen during nighttime hours, and FIG. 1C showing a sectional view indicating the relationship between a panel 1 and a panel main body 2. The panel structure pertaining to the first embodiment (referred to as “the first panel structure”) is composed of the panel main body 2 and the panel 1. The panel main body 2 is formed in substantially the shape of a quadrilateral frame by using a synthetic resin material, for example. The panel 1, which is made of a light transmitting material, is fixedly supported on the quadrilateral frame portion of the panel main body 2. The examples of the light transmitting material for use include: acrylironitrile-butadiene-styrene copolymer (ABS for short); polycarbonate (PC for short); acrylic substance; and glass. In this construction, the direction of the length of the panel main body 2 is defined as an x direction, the direction of the thickness of the panel 1 is defined as a z direction, and a direction perpendicular to the x and z directions is defined as a y direction. The x direction, the y direction, and the x direction are indicated by x, y, z, respectively, in FIGS. 1A through 1C.

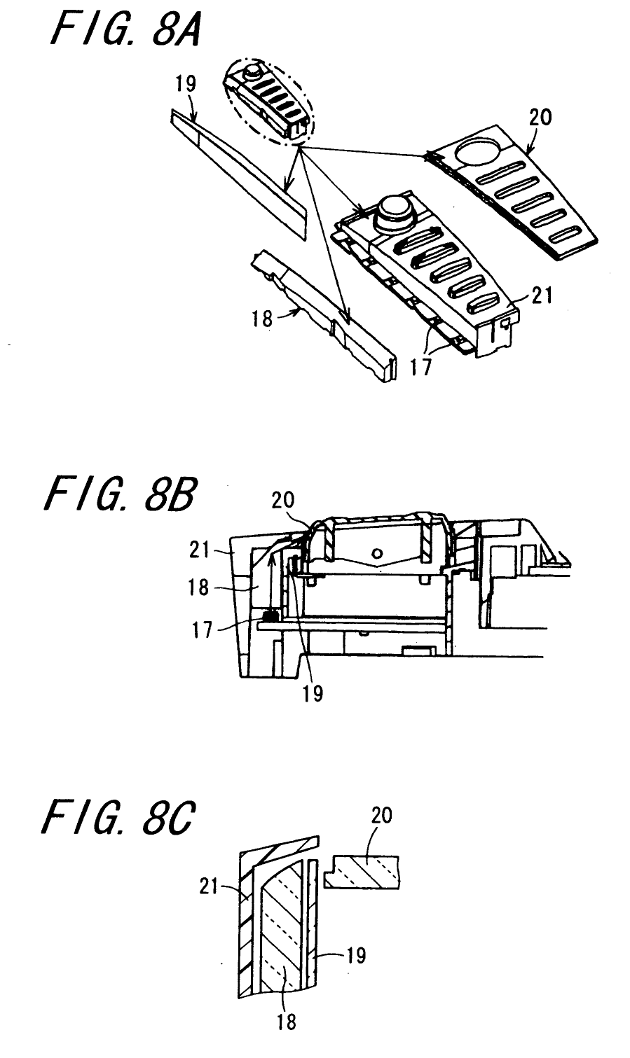

That part of the panel main body 2 which constitutes the quadrilateral frame portion, namely a recess 2a, is subjected to a processing of applying a design to form an asperity or embossing pattern which is visually perceptible through the panel 1. Such a design-applied portion 3 is formed integrally with the panel main body 2 in the first embodiment. Moreover, the panel main body 2 has, at its x direction-wise opposite ends, a light-guiding plate and a plurality of light emitting diodes (LED for short) acting as a light source (not shown in the figures). A plurality of LEDs disposed at one x direction-wise end of the panel main body 2 are spaced out from one another along the y direction at a constant interval, so as for light emitted to one z direction from each of the LEDs to enter one x direction-wise end of the panel 1 by way of the light-guiding plate. The light incident upon one x direction-wise end of the panel 1 is then conduct to the other x direction-wise end of the panel 1 (refer to FIGS. 8A through 8C).

A plurality of LEDs disposed at the other x direction-wise end of the panel main body 2 are spaced out from one another along the y direction at a constant interval, so as for light emitted from each of the LEDs to enter the other x direction-wise end of the panel 1 by way of the light-guiding plate. The light incident upon the other x direction-wise end of the panel 1 is then conducted to one x direction-wise end of the panel 1. As shown in FIG. 1B, when the LEDs are turned on to emit light which is conducted along the x-y plane of the panel 1, the design-applied portion 3 is shielded with the light illuminating the panel 1 and is thus visually imperceptible. On the other hand, as shown in FIG. 1A, when the LEDs are turned off, no light is conducted to the panel 1, wherefore the viewability of the design-applied portion 3 can be secured in the panel 1.

According to the first panel structure thus far described, during daytime hours for example, the design-applied portion 3 of the panel main body 2 is visually perceptible through the panel 1 made of a light transmitting material. On the other hand, during nighttime hours for example, when light is so conducted as to travel from one x direction-wise end to the other x direction-wise end in the panel 1, as well as when light is so conducted as to travel from the other x direction-wise end to one x direction-wise end in the panel 1, the design-applied portion 3 is shielded with the light illuminating the panel 1. In this way, by making a difference between the daytime visual impression and the nighttime visual impression of the panel, it is possible to impart a two types of design images to the panel structure. Moreover, by forming the design-applied portion 3 integrally with the panel main body 2, it is possible to reduce the number of the constituent components of the first panel structure, and thereby reduce the manufacturing cost. Further, the number of man-hours can also be reduced.

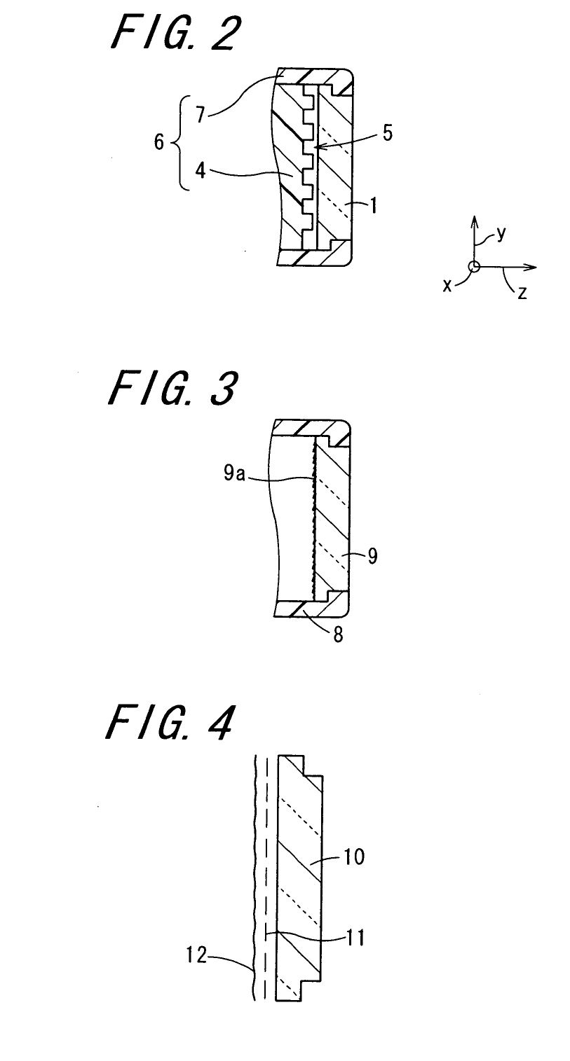

FIG. 2 is a sectional view of the panel structure according to a second embodiment of the invention, wherein a design-applied portion 5 is formed integrally with an inner panel section 4. The panel structure pertaining to the second embodiment, namely the second panel structure includes a panel main body 6 and a panel 1. The panel main body 6 is composed of an outer panel section 7 and the inner panel section 4. Of these panel sections, the outer panel section 7 is built as a casing for supporting the inner panel section 4 and the panel 1. For example, the outer panel section 7 is formed in substantially the shape of a quadrilateral frame by using a synthetic resin material, and the inner panel section 4 is made of a synthetic resin material. The inner panel section 4 is disposed inside the outer panel section 7. The design-applied portion 5, which is formed integrally with the inner panel section 4, is spaced only a predetermined short distance away from the back surface of the panel 1.

According to the second panel structure thus far described, of the panel sections constituting the panel main body 6, especially the inner panel section 4 has the design-applied portion 5 formed integrally therewith. With this construction, in contrast to the case where the design-applied portion 5 is formed independently of the panel main body, the manufacturing cost can be reduced. Being formed so as to have the design-applied portion 5, the inner panel section 4 can readily be replaced with another including the design-applied portion 5 of different design in accordance with car models, the grades of car models, and age groups or distinction of sex about target users, on an as needed basis. In other words, users are able to enjoy a variety of applied designs simply by replacing the inner panel section 4 alone, with the outer panel section 7 and the panel 1 left intact as a common component. As a result, according to the second panel structure, the general versatility of the outer panel section 7 and the panel 1 can be enhanced. Otherwise, the same effects as achieved in the first panel structure can be achieved in the second panel structure.

FIG. 3 is a sectional view of the panel structure according to a third embodiment of the invention, wherein the back surface of a panel is subjected to printing process. The panel structure pertaining to the third embodiment, namely the third panel structure includes a panel main body 8 and a panel 9. The panel 9 has its back surface facing inwardly of an electronic apparatus subjected to printing process to form a printing-processed portion 9a. The printing-processed portion 9a is visually perceptible from the side of the top surface of the panel 9 facing outwardly of the electronic apparatus. When the LEDs are each turned on to emit light which is conducted along the x-y plane of the panel 9, the printing-processed portion 9a is shielded with the light illuminating the panel 9 and is thus visually imperceptible. On the other hand, when the LEDs are each turned off, no light is conducted to the panel 9, wherefore the viewability of the printing-processed portion 9a can be secured.

According to the third panel structure thus far described, by performing printing process especially on the back surface of the panel, it is possible to attain the following advantages. That is, the panel 9 can readily be replaced with another including the printing-processed portion 9a of different design on an as needed basis. In other words, users are able to enjoy a variety of designs of the printing-processed portion 9a simply by replacing the panel 9 alone, with the panel main body 8 left intact as a common component. As a result, according to the third panel structure, the general versatility of the panel main body 8 can be enhanced.

Moreover, the printing-processed portion 9a can be secured to the back surface of the panel by using a fixing member such as a double-faced adhesive tape. This makes it possible to perform printing process in the panel swiftly with ease. In this case, since a design is not directly printed to the panel in itself, it is possible to attain a high degree of flexibility in design, as well as to reduce the manufacturing cost in contrast to the case where a design is printed directly to the panel in itself. Otherwise, the same effects as achieved in the first panel structure can be achieved in the third panel structure. Further, the panel having a print of various design can be put into commercial production as an independent article. By the same token, the printing-processed portion 9a having a print of various design can be put into commercial production as an independent article.

FIG. 4 is a sectional view of the panel structure according to a fourth embodiment of the invention, wherein the back surface of a panel 10 is subjected to UV-stripe printing process. In the panel structure pertaining to the fourth embodiment, namely the fourth panel structure, the panel 10 has its back surface subjected to UV (Ultra Violet) stripe printing process and color printing process using a color corresponding to the color of an inner panel. With use of a fixing member such as a double-faced adhesive tape, at least one of a UV stripe printed portion 11 and an inner-panel-color printed portion 12 can be secured to the back surface of the panel 10. This makes it possible to perform printing process in the panel 10 swiftly with ease. Moreover, the inner-panel-color printed portion 12 serves to add a quality appearance to the panel structure. Otherwise, the same effects as achieved in the third panel structure can be achieved in the fourth panel structure.

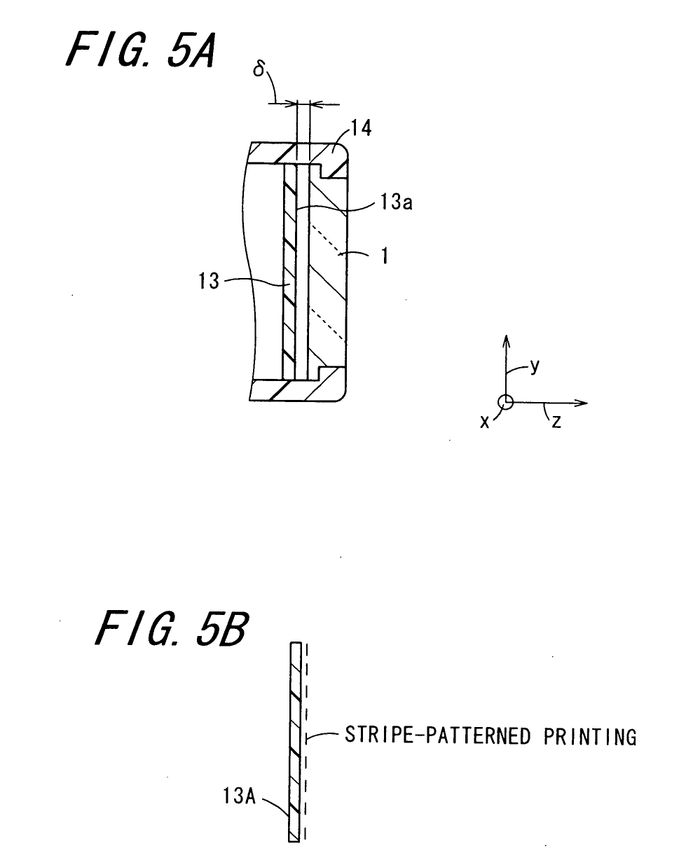

FIGS. 5A and 5B are views of the panel structure according to a fifth embodiment of the invention, with FIG. 5A showing a sectional view indicating the relationship between a panel 1 and a panel main body 14 including an outer panel and a stripe-patterned print sheet body 13, and FIG. 5B showing a sectional view schematically illustrating a polycarbonate-made print sheet body 13A to which a stripe pattern is printed. The panel structure pertaining to the fifth embodiment, namely the fifth panel structure includes the panel main body 14, the panel 1, and the stripe-patterned print sheet body 13. For example, the stripe-patterned print sheet body 13 is made of polycarbonate. The print sheet body 13 is disposed inside the panel main body 14. The print sheet body 13 has, on its one surface, a printing-processed portion 13a spaced only a predetermined short distance δ away from the back surface of the panel 1.

According to the fifth panel structure thus far described, it is possible to impart two types of design images to the panel structure by providing the print sheet body 13 separately without the necessity of performing printing process in the panel 1. Accordingly, in contrast to the case where a design is printed directly to the panel in itself, a high degree of flexibility in design can be attained. Moreover, the print sheet body 13 can readily be replaced with another having a different design in accordance with car models, the grades of car models, and age groups or distinction of sex about target users, on an as needed basis. Otherwise, the same effects as achieved in the first to fourth panel structures can be achieved in the fifth panel structure. Note that it is possible to perform medium printing on one surface of the polycarbonate-made print sheet body 13A to obtain a medium print sheet body. Instead thereof, it is also possible to perform emboss printing to obtain an embossed print sheet body.

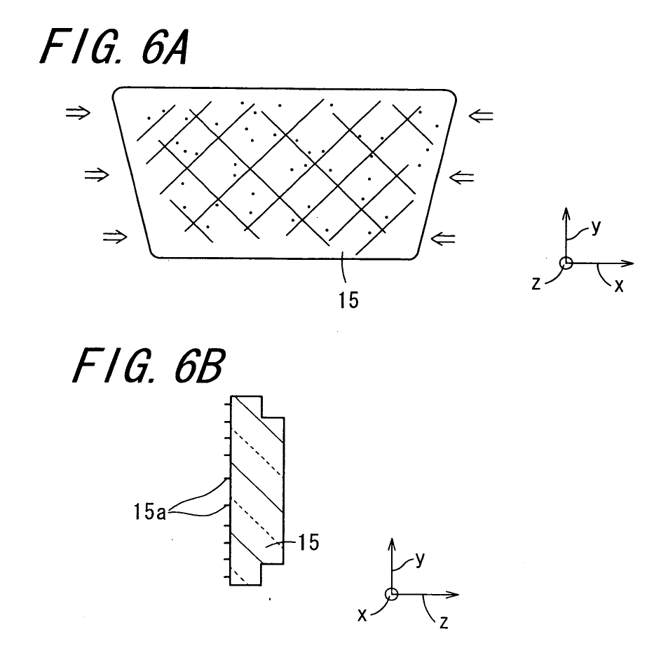

FIGS. 6A and 6B are views of the panel structure according to a sixth embodiment of the invention, with FIG. 6A showing a front view illustrating how light emitted from a light source is conducted to a panel 15 embossed with a design, and FIG. 6B showing a sectional view of the state depicted in FIG. 6A. In the panel structure pertaining to the sixth embodiment, namely the sixth panel structure, the panel 15 has its back surface subjected to a process of applying a design (referred to as “embossing process”) to form a design-applied portion having asperity 15a. By adopting the embossing technique, it is possible to impart two types of design images to the panel structure at low cost. Otherwise, the same effects as achieved in the third panel structure can be achieved in the sixth panel structure.

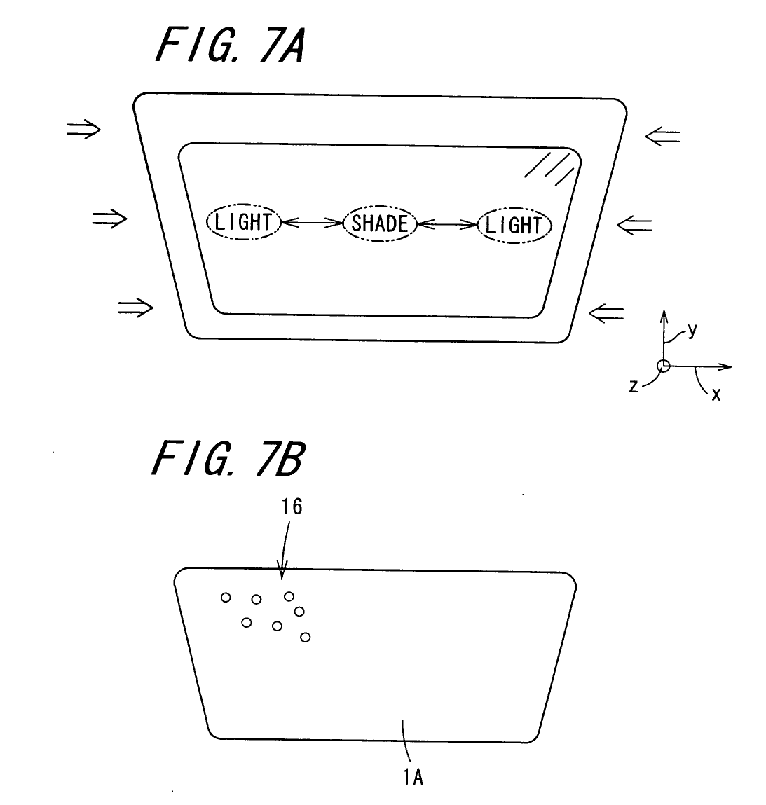

FIGS. 7A and 7B are views of the panel structure according to a seventh embodiment of the invention, with FIG. 7A showing a front view schematically illustrating a light-shade distribution in a panel, and FIG. 7B showing a front view illustrating dot and pitch adjustment in medium printing. In such a structure as that in which light emitted from a light source is conducted so as to travel simply from one end to the other end in a panel (conventional structure), as shown in FIG. 7A, the opposite x direction-wise ends of the panel are brighter than the other area because of the close proximity to the light source. That is, the value of light density in part of the panel as observed in the z direction is higher relatively to the value of light density in the midportion of the panel as observed in the x direction. In contrast to such a conventional panel structure in which the light density value varies greatly along the x direction, in this construction, as shown in FIG. 7B, by making adjustment to the dot and pitch in a medium print 16, it is possible to make the light density value of the panel 1A uniform (x direction-wise, in particular). Accordingly, a panel of certain high quality can be produced in a simple manner with reliability.

FIGS. 8A through 8C are views of the panel structure according to an eighth embodiment of the invention, with FIG. 8A showing an exploded perspective view thereof, FIG. 8B showing a sectional view indicating the relationship among a light source 17, a light-guiding plate 18, a filter 19, and a panel 20, and FIG. 8C showing a sectional view of the principal portion of the panel structure. The panel structure pertaining to the eighth embodiment, namely the eighth panel structure includes a panel main body 21, the panel 20, the light-guiding plate 18, and the filter 19. For example, the visual impression of the panel 20 during daytime hours, namely during the time the light is kept in a turned-off state, is caused to vary in conformity with the following four conditions:

(1) constituting the panel 20 by using an originally colored material;

(2) performing printing process on the panel 20;

(3) interposing a sheet body other than the filter 19 between the panel 20 and the light-guiding plate 18; and

(4) coloring the light-guiding plate 18.

On the other hand, the visual impression of the panel 20 during nighttime hours, namely during the time the light is kept in a turned-on state, is caused to vary in conformity with the following six conditions:

(5) coloring the filter 19;

(6) performing printing process on the light-guiding plate 18;

(7) coloring the light-guiding plate 18;

(8) attaching a colored cap to the light source, namely LED 17;

(9) performing printing process on each of the opposite x direction-wise ends of the panel 20; and

(10) employing an ultraviolet light source.

By selectively combining these conditions (1) through (4) as well as (5) through (10) with one another, it is possible to realize desired color tones freely in a short period of time at low cost. It is also possible to make uniform the light density value of the panel 20 with ease. It should be noted that changes and modifications may be made in the embodiments as set forth hereinabove without departing from the spirit of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A panel structure for an electronic apparatus comprising:
a panel main body having an design-applied portion or a printing-processed portion; and
a panel made of a light transmitting material, for lowering viewability of the design-applied portion or printing-processed portion when light is conducted from a side part of the panel is lower than viewability of the design-applied portion or printing-processed portion when light is not conducted from the side part by shielding the design-applied portion or printing-processed portion with light.

2. The panel structure of claim 1, wherein the printing-processed portion is composed of a print sheet body.

3. The panel structure of claim 1, wherein the printing-processed portion is fashioned by means of medium printing.

4. The panel structure of claim 1, wherein the design-applied portion includes asperity.

5. The panel structure of claim 1, wherein the light transmitting material is selected from any one of acrylonitrile-butadiene-styrene copolymer, polycarbonate, acrylic substance, and glass.

6. A panel structure for an electronic apparatus comprising:
a panel main body having a design-applied portion or printing-processed portion;
a light source provided on an end of the panel main body, for emitting light; and
a panel made of a light transmitting material, provided on an anterior surface of the panel main body, the panel being illuminated from a side part thereof with the light emitted from the light source which light shields the design-applied portion or printing-processed portion.

7. An electronic apparatus comprising:
a panel main body having a design-applied portion or printing-processed portion;
a light source provided on an end of the panel main body, for emitting light; and
a panel made of a light transmitting material, for lowering viewability of the design-applied portion or printing-processed portion when light is conducted from a side part of the panel is lower than viewability of the design-applied portion or printing-processed portion when light is not conducted from the side part by shielding the design-applied portion or printing-processed portion with light.

8. The electronic apparatus of claim 7, wherein the panel main body is applied to an in-vehicle apparatus.

9. The electronic apparatus of claim 7, wherein the light source is composed of a plurality of light emitting diodes, and
the light emitting diodes are spaced out from one another at a constant distance.

10. The electronic apparatus of claim 7, further comprising a light-guiding plate disposed between the light source and the panel, for conducting the light to the side part of the panel.
